(19) United States
(12) Patent Application Publication
(10) Pub. No.: US 2010/0149183 A1
(43) Pub. Date: Jun. 17, 2010

(54) IMAGE MOSAICING SYSTEMS AND METHODS

(76) Inventors: Kevin E. Loewke, Menlo Park, CA (US); David B. Camarillo, Aptos, CA (US); J. Kenneth Salisbury, JR., Mountain View, CA (US); Sebastian Thrun, Stanford, CA (US)

Correspondence Address: CRAWFORD MAUNU PLLC, 1150 NORTHLAND DRIVE, SUITE 100, ST. PAUL, MN, 55120, US

(21) Appl. No.: 12/518,995

(22) PCT Filed: Dec. 14, 2007
(86) PCT No.: PCT/US2007/087622

§ 371 Date: Nov. 25, 2009

Related U.S. Application Data
(60) Provisional application No. 60/870,147, filed on Dec. 15, 2006.
(60) Provisional application No. 60/979,588, filed on Oct. 12, 2007.

(51) Int. Cl. G06T 17/00; G09G 5/00

(52) U.S. Cl. 345/424; 345/634

(57) ABSTRACT

Mosaicing methods and devices are implementing in a variety of manners. One such method is implemented for generation of a continuous image representation of an area from multiple images consecutively received from an image sensor. A location of a currently received image is indicated relative to the image sensor. A position of a currently received image relative to a set of previously received images is indicated with reference to the indicated location. The currently received image is compared to the set of previously received images as a function of the indicated position. Responsive to the comparison, adjustment information is indicated relative to the indicated position. The currently received image is merged with the set of previously received images to generate data representing a new set of images.

### RELATED PATENT DOCUMENTS

This patent document claims the benefit, under 35 U.S.C. §119(e), of U.S. Provisional Patent Application Ser. No. 60/979,588 filed on Oct. 12, 2007 and entitled: “Image Mosaicing System and Method;” and of U.S. Provisional Patent Application Ser. No. 60/870,147 filed on Dec. 15, 2006 and entitled: “Sensor-Based Near-Field Imaging Mosaicing System and Method;” each of these patent applications, including the Appendices therein, is fully incorporated herein by reference.

### FIELD OF INVENTION

This invention relates generally to image mosaicing, and more specifically to systems and methods for performing image mosaicing while mitigating for cumulative registration errors or scene deformation or real-time image mosaicing for medical applications.

### BACKGROUND

In recent years, there has been much interest in image mosaicing of static scenes for applications in areas such as panorama imaging, mapping, tele-operation, and virtual travel. Traditionally, an image mosaic is created by stitching two or more overlapping images together to form a single larger composite image through a process involving registration, warping, re-sampling, and blending. The image registration step is used to find the relative geometric transformation among overlapping images.

Image mosaicing can be useful for medical imaging. In the near future, small-scale medical imaging devices are likely to become ubiquitous and our ability to deliver them deep within the body should improve. For example, the evolution of endoscopy has recently led to the micro-endoscope, a minimally invasive imaging catheter with cellular resolution. Micro-endoscopes are replacing traditional tissue biopsy by allowing for tissue structures to be observed in vivo for optical biopsy. These optical biopsies are moving towards unifying diagnosis and treatment within the same procedure. A limitation of many micro-endoscopes and other micro-imaging devices, however, is their limited fields-of-view.

There are challenges associated with image mosaicing. One such challenge is dealing with cumulative registration errors. That is, if the images are registered in a sequential pair-wise fashion, alignment errors will propagate through the image chain, becoming most prominent when the path closes a loop or traces back upon itself. A second challenge is dealing with deformable scenes. For example, when imaging with micro-endoscopes, scene deformations can be induced by the imaging probe dragging along the tissue surface.

### SUMMARY

Consistent with one embodiment of the present invention, a method is implemented for generation of a continuous image representation of an area from multiple images consecutively received from an image sensor. A location of a currently received image is indicated relative to the image sensor. A position of a currently received image relative to a set of previously received images is indicated with respect to the indicated location. The currently received image is compared to the set of previously received images as a function of the indicated position. Responsive to the comparison, adjustment information is indicated relative to the indicated position. The currently received image is merged with the set of previously received images to generate data representing a new set of images.

Consistent with another embodiment of the present invention, a system is implemented for generation of a continuous image representation of an area from multiple images consecutively received from an image sensor. A processing circuit indicates location of a currently received image relative to the image sensor. A processing circuit indicates a position of a currently received image relative to a set of previously received images with respect to the indicated location. A processing circuit compares the currently received image to the set of previously received images as a function of the indicated position. Responsive to the comparison, a processing circuit indicates adjustment information relative to the indicated position. A processing circuit merges the currently received image with the set of previously received images to generate data representing a new set of images.

The above summary is not intended to describe each illustrated embodiment or every implementation of the present invention.

### BRIEF DESCRIPTION OF THE FIGURES

The invention may be more completely understood in consideration of the detailed description of various embodiments of the invention that follows in connection with the accompanying drawings, in which:

FIG. 1 shows a flow chart according to an example embodiment of the invention;

FIG. 2 shows a representation of using mechanical actuation to move the imaging device, consistent with an example embodiment of the invention;

FIG. 3A shows a representation of creating 2D mosaics at different depths to create a 3D display, consistent with an example embodiment of the invention;

FIG. 3B shows a representation of creating a 3D volume mosaic, consistent with an example embodiment of the invention;

FIG. 4 shows a representation of a micro-endoscope with a slip sensor traveling along a tissue surface and shows two scenarios where there is either slipping of the micro-endoscope or stretching of the tissue, consistent with an example embodiment of the invention;

FIG. 5 shows a representation of an operator holding the distal end of a micro-endoscope for scanning and creating an image mosaic of a polyp, consistent with an example embodiment of the invention;

FIG. 6 shows a representation of an imaging device mounted on a robot for tele-operation with a virtual surface for guiding the robot, consistent with an example embodiment of the invention;

FIG. 7 shows a representation of an image mosaic used as a navigation map, with overlaid tracking dots that represent the current and desired locations of the imaging device and other instruments, consistent with an example embodiment of the invention;

FIG. 8 shows a representation of a capsule with on-board camera and range finder traveling through the stomach and imaging a scene of two different depths, consistent with an example embodiment of the invention;

FIG. 9 shows a flow chart of a method for processing images and sensor information to create a composite image mosaic for display, consistent with an example embodiment of the invention;

FIG. 10 shows a flow chart of a method of using sensor information to determine the transformation between poses of the imaging device, consistent with an example embodiment of the invention;

FIG. 11 shows a flow chart of a method of determining the hand-eye calibration, consistent with an example embodiment of the invention;

FIG. 12A shows a flow chart of a method of using the local image registration to improve the stored hand-eye calibration, consistent with an example embodiment of the invention;

FIG. 12B shows a flow chart of the method of using the local image registration to determine a new hand-eye calibration, consistent with an example embodiment of the invention;

FIG. 13 shows a flow chart of the method of determining the global image registration, consistent with an example embodiment of the invention;

FIG. 14 shows a flow chart of a method of determining the local image registration, consistent with an example embodiment of the invention;

FIG. 15 shows a flow chart of a method of using sensor information for both the global and local image registrations, consistent with an example embodiment of the invention;

FIG. 16 shows a flow chart of a method of using the local image registration to improve the sensor measurements by sending the estimated sensor error through a feedback loop, consistent with an example embodiment of the invention;

FIG. 17 shows a representation of one such embodiment of the invention, showing the imaging device, sensors, processor, and image mosaic display, consistent with an example embodiment of the invention;

FIG. 18 shows a representation of an ultrasound system tracking an imaging probe as it creates an image mosaic of the inner wall of the aorta, consistent with an example embodiment of the invention;

FIG. 19 shows a representation of a micro-endoscope equipped with an electro-magnetic coil being dragged along the wall of the esophagus for creating an image mosaic, consistent with an example embodiment of the invention;

FIG. 20 shows an implementation where the rigid links between images are replaced with soft constraints, consistent with an example embodiment of the invention; and

FIG. 21 shows an implementation where local constraints are placed between the neighboring nodes within each image, consistent with an example embodiment of the invention.

While the invention is amenable to various modifications and alternative forms, examples thereof have been shown by way of example in the drawings and will be described in detail. It should be understood, however, that the intention is not to limit the invention to the particular embodiments shown and/or described. On the contrary, the intention is to cover all modifications, equivalents, and alternatives falling within the spirit and scope of the invention

### DETAILED DESCRIPTION

The following description of the various embodiments of the invention is not intended to limit the invention to these embodiments, but rather to enable any person skilled in the art to make and use this invention.

Various embodiments of the present invention have been found to be particularly useful for medical applications. For example, endoscopic-based imaging is often used as an alternative to more evasive procedures. The small size of endoscopes mitigates the evasiveness of the procedure; however, the size of the endoscope can be a limiting factor in field-of-view of the endoscope. Handheld devices, whether used in vivo or in vitro, can also benefit from various aspects of the present invention. A particular application involves a handheld microscope adapted to scan dermatological features of a patient. Although not limited to medical applications, an understanding of aspects of the invention can be obtained by a discussion thereof.

Various embodiments of the present invention have also been found to be particularly useful for applications involving endoscopic imaging of tissue structures in hard to reach anatomical locations such as the colon, stomach, esophagus, or lungs.

A particular embodiment of the invention involves the mosaicing of images captured using a borescope/boroscope. Borescopes can be particularly useful in many mechanical and industrial applications. Example applications include, but are not limited to, the aircraft industry, building construction, engine design/repair, and various maintenance fields. A specific type of borescope can be implemented using a gradient-index (GRIN) lens that allow for relatively high-resolution images using small diameter lenses. The skilled artisan would recognized that many of the methods, systems and devices described in connection with medical applications would be applicable to non-medical imaging, such as the use of borescopes in mechanical or industrial applications.

Consistent with one embodiment of the present invention, a method is implemented for generation of a continuous image representation of an area from multiple images obtained from an imaging device having a field of view. The method involves positioning the field of view to capture images of respective portions of an area, the field of view having a position for each of the captured images. Image mosaicing can be used to widen the field-of-view by combining multiple images into a single larger image.

For many medical imaging devices, the geometric relationship between the images and the imaging device is known. For example, many confocal microscopes have a specific field of view and focal depth that constitute a 2D cross-section beneath a tissue surface. This known section geometry allows for images to be combined into an image map that contains specific spatial information. In addition, this allows for processing methods that can be performed in real-time by, for example, aligning images through translations and rotations within the cross-sectional plane. The resulting image mosaic provides not only a larger image representation but also architectural information of a volumetric structure that may useful for diagnosis and/or treatment.

The geometric locations of the field of view relative to the image sensor are indicated. The positions of the field of view are indicated, respectively, for the captured images. Adjustment information is indicated relative to the indicated positions. The indicated locations and positions and adjustment information are used to provide an arrangement for the captured images. The arrangement of the captured images provides a continuous image representation of the area.

Consistent with another embodiment of the present invention, the indicated positions are used for an initial arrangement of the captured images, and within the initial arrangement, proximately-located ones of the captured images are compared to provide a secondary arrangement.

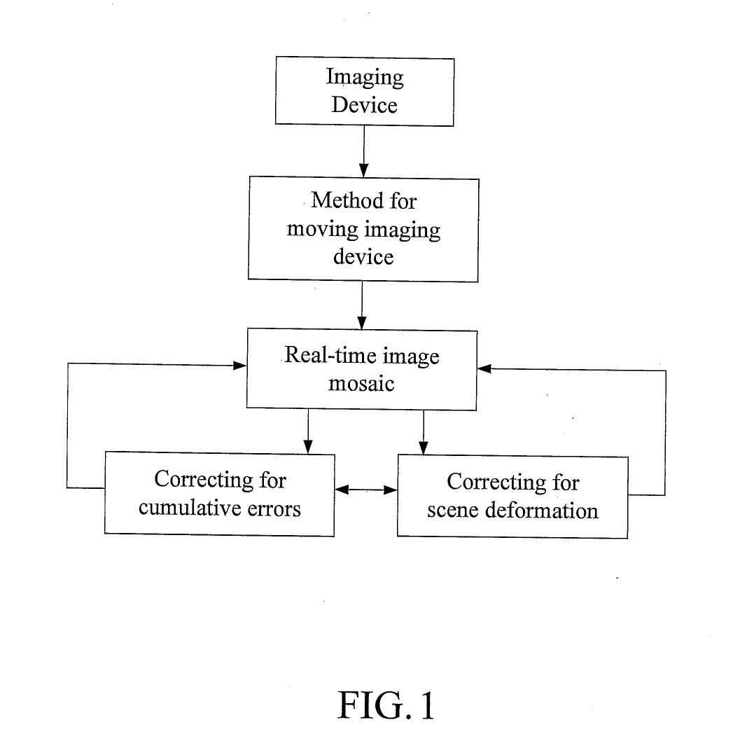

FIG. 1 shows a flow diagram for imaging according to an example embodiment of the present invention. An imaging device is used for taking images of a scene. Different images are captured by moving the image device or the field of view of images captured there from. The images can be processed in real-time to create a composite image mosaic for display. Cumulative image registration errors and/or scene deformation can be corrected by using methodology described herein.

Image registration can be achieved through different computer vision algorithms such as, for example, optical flow, feature matching, or correlation in the spatial or frequency domains. Image registration can also be aided by the use of additional sensors to measure the position and/or orientation of the imaging device.

Various embodiments of the invention can be specifically designed for real-time image mosaicing of tissue structures during in vivo medical procedures. Embodiments of the invention, however, may be used for other image mosaicing applications including, but not limited to, nonmedical uses may include structural health monitoring of aircraft, spacecraft, or bridges, underwater exploration, terrestrial exploration, and other situations where it is desirable to have a macro-scale field-of-view while maintaining micro-scale detail. As this list is non-exclusive, embodiments of the invention can be used in other mosaicing applications, including those that are subject to registration errors and/or deformable scenes. For example, aspects of the invention may be useful for image mosaicing or modeling of people and outdoor environments.

The invention can be implemented using a single imaging device or, alternatively, more than one imaging device could be used. A specific embodiment of the invention uses a micro-endoscope. Various other imaging devices are also envisioned including, but not limited to, an endoscope, a micro-endoscope, an imaging probe, an ultrasound probe, a confocal microscope, or other imaging devices that can be used for medical procedures. Such procedures may include, for example, cellular inspection of tissue structures, colonoscopy, or imaging inside a blood vessel. Further, the imaging device may alternatively be a digital camera, video camera, film camera, CMOS or CCD image sensor, or other imaging apparatus that records the image of an object. As an example, the imaging device may be a miniature diagnostic and treatment capsule or “pill” with a built-in CMOS imaging sensor that travels through the body for micro-imaging of the digestive track. In alternative embodiments, the imaging device could be X-ray, computed tomography (CT), ultrasound, magnetic resonance imaging (MRI), or other medical imaging modality.

In another embodiment of the invention, the image capture occurs using a system and/or method that provide accurate knowledge of relation between the captured image and the position of the image sensor. Such systems can be used to provide positional references of a cross-sectional image. The positional references are relative to the location of the image sensor. As an example, confocal microscopy involves a scanning procedure for capturing a set of pixels that together form an image. Each pixel is captured relative to the focus point of light emitted from a laser. This knowledge of the focal point, as well as the field of view, provides a reference between the position of the image sensor and the captured pixels. The estimated or known location of the image data can allow for image alignment techniques that are specific to the data geometry, and can allow for indication of the specific location of the images and image mosaics relative to the image sensor. The estimated or known location of the image data can also allow for images or image mosaics of one geometry to be registered and displayed relative to other images or image mosaics with a different geometry. This can be used to indicate specific spatial information regarding the relative geometries of multiple sets of data. Other types of similar image capture systems include, but are not limited to, confocal micro-endoscopy, multi-photon microscopy, optical coherence tomography, and ultrasound.

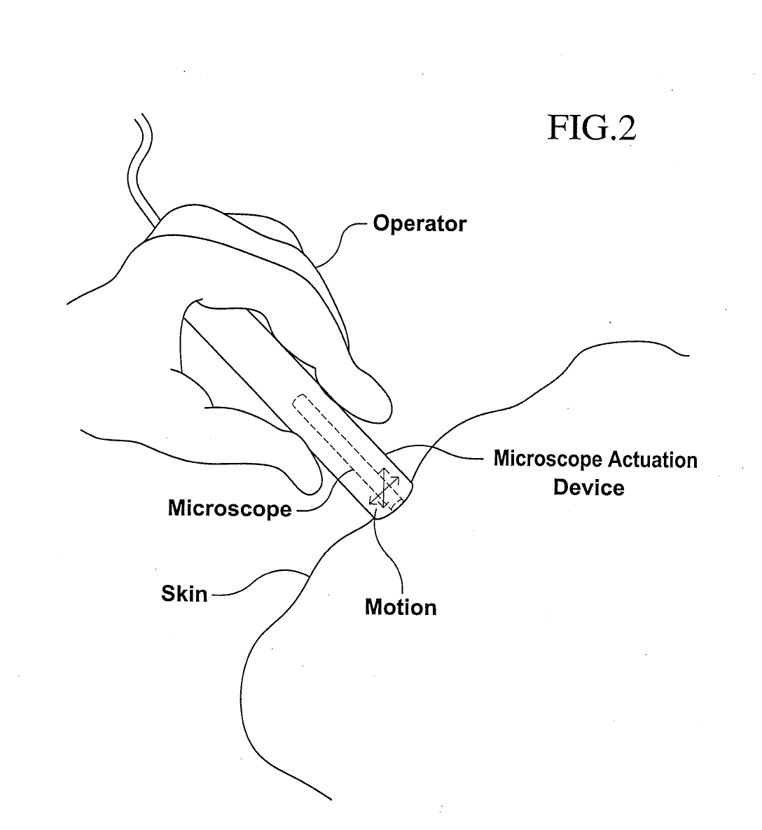

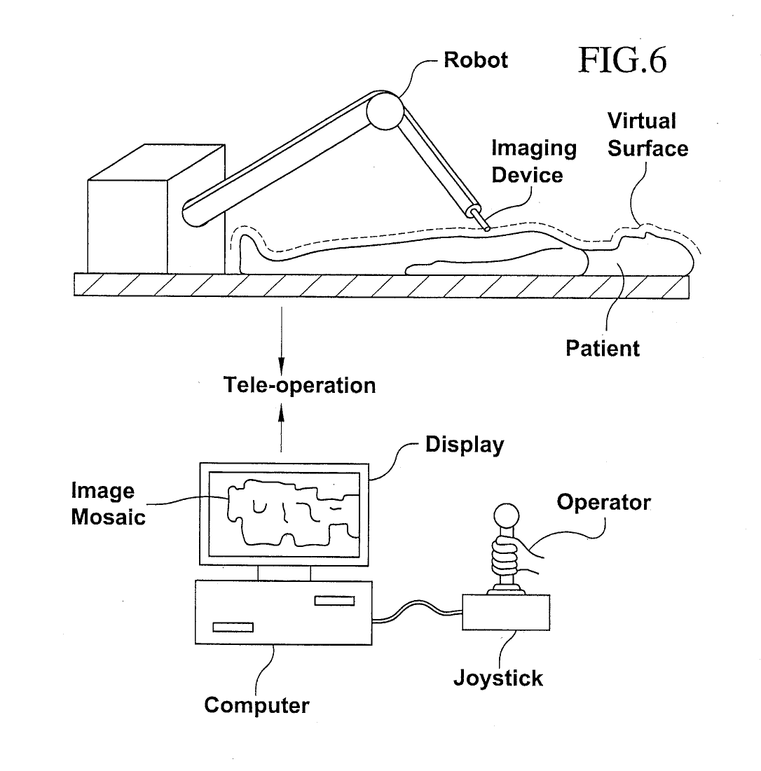

According to one embodiment of the invention, the imaging device can be manually controlled by an operator. As an example embodiment, the imaging device is a micro-endoscope, and the operator navigates the micro-endoscope by manipulating its proximal end. In another example, the imaging device is a hand-held microscope, and the operator navigates the microscope by dragging it along a tissue surface. In an alternative embodiment, the imaging device is moved by mechanical actuation, as described in connection with FIGS. 2 and 6. FIG. 2 shows one such example of this alternative embodiment. The imaging device is a hand-held microscope that is actuated using, for example, a miniature x-y stage or spiral actuation method. As another example of the alternative embodiment, the imaging device is a micro-endoscope actuated using magnetic force. In an alternative embodiment, the imaging device may be contained in an endoscope and directed either on or off axis. It may be actuated using remote pull-wires, piezo actuators, silicon micro-transducers, nitinol, air or fluid pressure, a micro-motor (distally or proximally located), a slender flexible shaft.

In an alternative embodiment, the imaging device is a miniature confocal microscope attached to a hand-held scanning device that can be used for dermatologic procedures. The scanning device includes an x-y stage for moving the microscope. The scanning device also includes an optional optical window that serves as the interface between the skin and the microscope tip. A small amount of spring force may be applied to ensure that the microscope tip always remains in contact with the window. The interface between the window and the microscope tip may also include a gel that is optically-matched to the window to eliminate air gaps and provide lubrication. The window of the scanning device is placed into contact with the patient's skin by the physician, possibly with the aid of a robotic aim. As the scanning device moves the microscope, an image mosaic is created. Position data from encoders on the scanning device or a pre-determined scanning motion can be used to indicate positions of the images and may be used for an initial image registration. The focal depth of the microscope can be adjusted during the procedure to create a 3D mosaic, or several 2D mosaics at different depths.

In one embodiment, the scanner acts a macro actuator, and the imaging device may include a micro actuator for scanning for individual pixels. The overall location of pixel in space is indicated by the combination of the micro and macro scanning motions. One approach to acquiring a volume efficiently is to first do a low resolution scan where the micro and macro scanners and controlled to cover maximal area in minimum time. Another approach is to randomly select areas to scan for efficient coverage. In one embodiment, the fast scan can then be used to select areas of interest (determined from user, automatic detection of molecular probe/marker, features for contrast intensity, etc.) for a higher resolution scan. The higher resolution scan can be registered to the lower resolution scan using sensors and/or registration algorithms.

FIG. 6 shows an imaging device that is actuated using semi-automatic control and navigation by mounting it on a robotic arm. The operator either moves the robotic arm manually or tele-operates the robotic arm using a joystick, haptic device, or any other suitable device or method. Knowledge of the 3D scene geometry may be used to create a virtual surface that guides the operator's manual or tele-operated movement of the robotic arm so as to not contact the scene but maintain a consistent distance. The operator may then create a large image mosaic “map” with confidence that the camera follows the surface appropriately.

In another embodiment, the imaging device is mounted to a robotic arm that employs fully-automatic control and navigation. Once the robotic arm has been steered to an initial location under fully-automatic control or tele-operation, the robot can take full control and scans a large area for creating an image mosaic. This fully-automatic approach ensures repeatability and allows monotonous tasks to be carried out quickly.

If gaps in the image mosaic are present, the operator or image processing detects them and the imaging device is moved under operator, semi-automatic, or fully-automatic control to fill in the gaps.

If there are large errors in the mosaic, the operator or image processing detects them and the imaging device is moved under operator, semi-automatic, or fully-automatic control to clean the mosaic up by taking and processing additional images of the areas with errors.

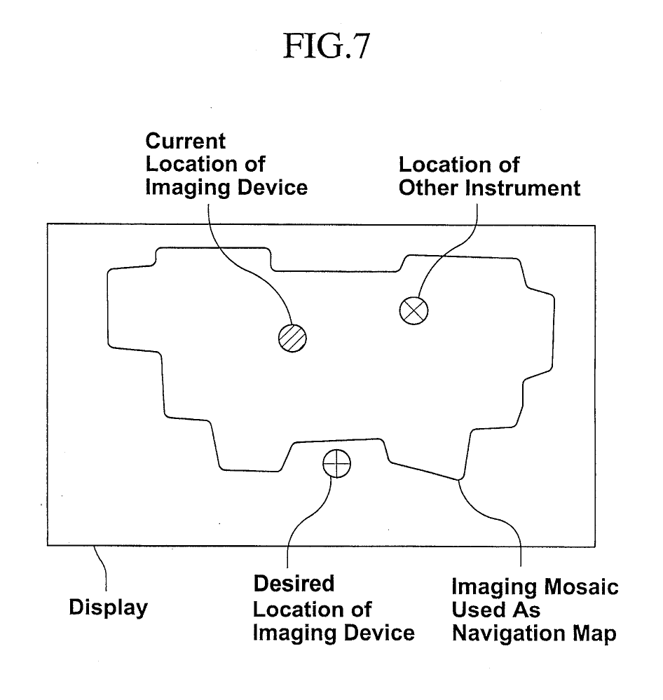

In another embodiment, as shown in FIG. 7, the image mosaic is used as a navigation map for subsequent control of the imaging device. That is, a navigation map is created during a first fly through over the area. When the imaging device passes back over this area, it determines its position by comparing the current image to the image mosaic map. The display shows tracker dots overlaid on the navigation map to show the locations of the imaging device and other instruments. Alternatively, once a 3D image map is created, the operator can select a specific area of the map to return to, and the camera can automatically relocate based on previously stored and current information from the sensors and image mosaic. This could allow the operator to specify a high level command for the device to administer therapy, or the device could administer therapy based on pattern recognition. Therapy could be administered by laser, injections, high frequency, ultrasound or another method. Diagnoses could also be made automatically based on pattern recognition.

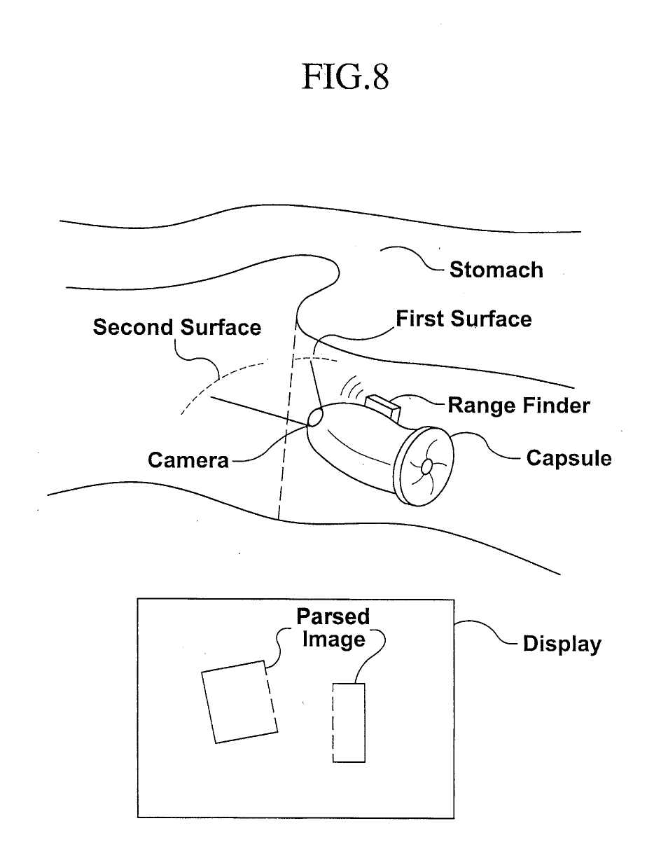

In another embodiment, as shown in FIG. 8, the imaging device is a capsule with a CMOS sensor for imaging in the stomach, and the sensor for measuring scene geometry is a range finder. Motion of the capsule is generated by computer control or tele-operated control. When the capsule approaches a curve, the range-finder determines that there is an obstruction in the field-of-view and that the capsule is actually imaging two surfaces at different depths. Using the range-finder data to start building the surface map, the image data can be parsed into two separate images and projected on two corresponding sections of the surface map. At this point there is only a single image, and the parsed images will therefore have no overlap with any prior images. The capsule then moves inside the stomach to a second location and takes another image of the first surface. In order to mosaic this image to the surface map, the position and orientation of the capsule as well as the data from the range-finder can be used.

One embodiment of the present invention involves processing the images in real-time to create a composite image mosaic for display. The processing can comprise the steps of: performing an image registration to find the relative motion between images; using the results of the image registration to stitch two or more images together to form a composite image mosaic; and displaying the composite image mosaic. In a specific embodiment, the image mosaic is constructed in real-time during a medical procedure, with new images being added to the image mosaic as the imaging device is moved. In another embodiment, the image mosaic is post-processed on a previously acquired image set.

In the one embodiment, the image registration is performed by first calculating the optical flow between successive images, and then selecting an image for further processing once a pre-defined motion threshold has been exceeded. The selected image is then registered with a previously selected image using the accumulated optical flow as a rough estimate and a gradient descent routine or template matching (i.e., cross-correlation in the spatial domain) for fine-tuning. In an alternative embodiment, the image registration could be performed using a combination of different computer-vision algorithms such as feature matching, the Levenberg-Marquardt nonlinear least-squares routine, correlation in the frequency domain, or any other image registration algorithm. In another embodiment, the image registration could incorporate information from additional sensors that measure the position and/or orientation of the imaging device.

In one embodiment, the imaging device is in contact with the surface of the scene, and therefore the image registration solves for only image translations and/or axial rotations. In an alternative embodiment, the imaging device is not in contact with the surface of the scene, and the image registration solves for image translations and/or rotations such as pan, tilt, and roll.

In one embodiment, the imaging device can be modeled as an orthographic camera, as is sometimes the case for confocal micro-endoscopes. In this scenario, prior to image registration each image may need to be unwarped due to the scanning procedure of the imaging device. For example, scanning confocal microscopes can produce elongated images due to the non-uniform velocity of the scanning device and uniform pixel-sampling frequency. The image therefore needs to be unwarped to correct for this elongation, which is facilitated using the know geometry and optical properties of the imaging device. In an alternative embodiment, the imaging device is lens-based and therefore modeled as a pinhole camera. Prior to image registration each image may need to be unwarped to account for radial and/or tangential lens distortion.

The result of the image registration is used to stitch two or more images together via image warping, re-sampling, and blending. In one embodiment, the blending routine uses multi-resolution pyramidal-based blending, where the regions to be blended are decomposed into different frequency bands, merged at those frequency bands, and then re-combined to form the final image mosaic. In an alternative embodiment, the blending routine could use a simple average or weighted-average of overlapping pixels, feathering, discarding of pixels, or any other suitable blending technique.

The image mosaic covers a small field-of-view that is approximately planar, and the image mosaic is displayed by projecting it onto a planar surface. In alternative embodiments, the image mosaic is displayed by projecting the image mosaic onto a 3D shape corresponding to the geometry of the scene. This 3D geometry and its motion over time are measured by the sensors previously mentioned.

In one instance, for low curvature surfaces, the scene can be approximated as planar and the corresponding image mosaic could be projected onto a planar manifold. In an alternative embodiment, if the scene can be approximated as cylindrical or spherical, the resulting image mosaic can be projected onto a cylindrical or spherical surface, respectively. If the scene has high curvature surfaces, it can be approximated as piece-wise planar, and the corresponding image mosaic could be projected to a 3D surface (using adaptive manifold projection or some other technique) that corresponds to the shape of the scene.

During fly-through procedures using, for example, a micro-endoscope, the image mosaic could be projected to the interior walls of that surface to provide a fly-through display of the scene. If the scene has high curvature surfaces, select portions of the images may be projected onto a 3D model of the scene to create a 3D image mosaic. If it is not desirable to view a 3D image mosaic, the 3D image mosaic can be warped for display on a planar manifold.

The resulting image mosaic is viewed on a computer screen, but alternatively could be viewed on a stereo monitor or 3D monitor. In some instances, the image mosaic can be constructed in real-time during a medical procedure, with new images being added to the image mosaic over time or in response as the imaging device moving. In other instances, the image mosaic can be used as a preoperative tool by creating a 3D image map of the location for analysis before the procedure. The image mosaic can also be either created before the operation or during the operation with tracker dots overlaid to show the locations of the imaging device and other instruments.

In one instance, the image mosaic is created and/or displayed at full resolution. In another instance, the image mosaic could be created and/or displayed using down-sampled images to reduce the required processing time. As an example of this instance, if the size of the full resolution mosaic exceeds the resolution of the display monitor, the mosaic is down-sampled for display, and all subsequent images are down-sampled before they are processed and added to the mosaic.

In some instances, the imaging device moves at a slow enough velocity such that the image registration can be performed on sequential image pairs. In other instances, the imaging device may slip or move too quickly for a pair-wise registration, and additional steps are needed to detect the slip and register the image to a portion of the existing mosaic. An example of this instance includes the use of a micro-endoscope that slips while moving across a piece of tissue. The slip is detected by a sensor and/or image processing techniques such as optical flow, and this information is used to register the image to a different portion of the exiting mosaic. In an alternative embodiment, the slip is large enough that the current image cannot be registered to any portion of the exiting mosaic, and a new mosaic is started. While the new mosaic is being constructed, additional algorithms such as a particle filter are searching for whether images being registered to the new mosaic can also be registered to the previous mosaic.

One embodiment of the invention involves correcting for cumulative image registration errors. This can be accomplished using various methodologies. Using one such methodology image mosaicing of static scenes is implemented using image registration in a sequential pairwise fashion using rigid image transformations. In some cases it is possible to assume that the motion between frames is small and primarily translational. Explicitly modeling of axial rotation can be avoided. This can be useful for keeping the optimizations methods linear (e.g., rotations can be modeled, but the resulting optimizations may then be nonlinear). The images are registered by first tracking each new frame using optical flow, and by selecting an image for further processing once a pre-defined motion threshold has been exceeded. The selected image is then registered with a previously selected image using the accumulated optical flow as a rough estimate and a gradient descent routine for fine-tuning. Optionally, several other image registration methods might be more suitable depending on the particular application.

Once a new image has been registered, it is then stitched to the existing image mosaic. A variety of different blending algorithms are available, such as those that use both a simple average of the overlapping pixels as well as multi-resolution pyramidal blending.

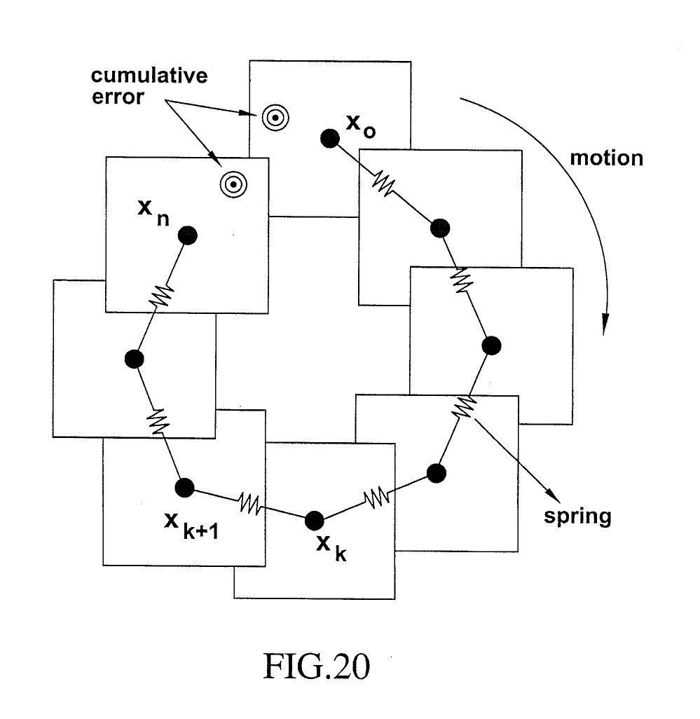

When sequentially placing a series of images within a mosaic, alignment errors can propagate through the series of images. A global image alignment algorithm is therefore implemented to correct for these errors. One possibility is to use frame-to-reference (global) alignments along with frame-to-frame (local) motion models, often resulting in a large and computationally demanding optimization problem. Another possibility is to replace the rigid links between images with soft constraints, or “springs.” These links can be bent, but bending them incurs a penalty. This idea is illustrated in FIG. 20.

Images are registered in 2D image space, and each image location is written as

Xₖ=(xₖ,yₖ)^{T}. (1)

The estimated correspondence (in one case found using optical flow and gradient descent) between two images is denoted as Δx_{k→k+1}. Images are registered in a sequential pairwise fashion, with link constraints placed between neighboring images:

Δx_{k→k+1}=xₖ₊₁−xₖ. (2)

When the image path attempts to close a loop or trace back upon a previously imaged area, cumulative registration errors will cause a misalignment with the mosaic, thereby requiring additional link constraints. For example, if the image chain attempts to close the loop by stitching the Nth image to the 1^{St} (0^{th}) image, a constraint would be based on the estimated correspondence Δx_{0→n}. The Nth image would then have two constraints: one with the previous neighboring image, and one with the 0^{th} image. When an image closes the loop the correspondence with the pre-existing mosaic can be found via template matching or some other suitable technique. That is, the location of the final image in the loop is determined relative to the pre-existing mosaic as the location where the normalized cross-correlation is maximized.

In a more general case, the kₜₕ image could overlap with either a neighboring image or any arbitrary location in the pre-existing mosaic. This general constraint is of the form

$$Δ {x}_{k -> l} = \underbrace{{x}_{l} - {x}_{k}}_{= : Δ {\hat{x}}_{k -> l}} . \qquad ( 3 )$$

To handle cumulative errors in the mosaic, a violation (or stretch) of these link constraints is allowed. To achieve this, each initial registration is given a probability distribution for the amount of certainty in the measurement. In one instance, this distribution can be assumed to be Gaussian with potentials placed at each link between the kₜₕ and lₜₕ images:

$${h}_{k -> l} = {\vert 2 π Σ \vert}^{- \frac{1}{2}} exp \{ - \frac{1}{2} {( Δ {x}_{k -> l} - Δ {\hat{x}}_{k -> l} )}^{T} {Σ}^{- 1} ( Δ {x}_{k -> l} - Δ {\hat{x}}_{k -> l} ) \} \qquad ( 4 )$$

where Σ is a diagonal covariance matrix that specifies the strength of the link. The covariance parameters can be chosen based on the quality of initial registration, such as quantified by the sum-of-squared difference in pixel intensities. The negative logarithm of the potentials, summed over all links, is written as (constant omitted)

$$H = {\sum }_{k -> l} {( Δ {x}_{k -> l} - Δ {\hat{x}}_{k -> l} )}^{T} {Σ}^{- 1} ( Δ {x}_{k -> l} - Δ {\hat{x}}_{k -> l} ) . \qquad ( 5 )$$

Equation (5) represents the error between the initial image registration and the final image placement. By minimizing (5), (4) is maximized, and thus the probability of correct registration is maximized. Therefore, the function H can be minimized over the parameters ΔX.

To minimize H, a system of overdetermined linear equations that can be solved via linear least-squares is setup. \tilde{X} is the state vector containing all of the camera poses Xk, and u as the state vector containing all of the correspondence estimates Δx_{k→l}. The matrix J is the Jacobian of the motion equations (3) with respect to the state \tilde{x}. The likelihood function H can be re-written as

H=(u−J\tilde{x})^{T}\tilde{Σ}⁻¹(u−J\tilde{x}). (6)

By taking the derivative of this equation and setting it equal to zero, it can be shown that the \tilde{x}maximizes the probability of correct image registrations. This gives

(J^{T}\tilde{Σ}⁻¹J)\tilde{x}=J^{T}\tilde{Σ}⁻¹u, (7)

which can be solved using least-squares.

The global optimization algorithm is used to correct for global misalignments, but it does not take into account local misalignments due to scene deformation. This becomes important when imaging with a micro-endoscope for two reasons. First, deformations can occur when the micro-endoscope moves too quickly during image acquisition. This skew effect is a common phenomenon with scanning imaging devices, where the output image is not an instantaneous snapshot but rather a collection of data points acquired at different times. Second, deformations can occur when the micro-endoscope's contact with the surface induces tissue stretch. A local alignment algorithm is used to accommodate these scene deformations and produce a more visually accurate mosaic.

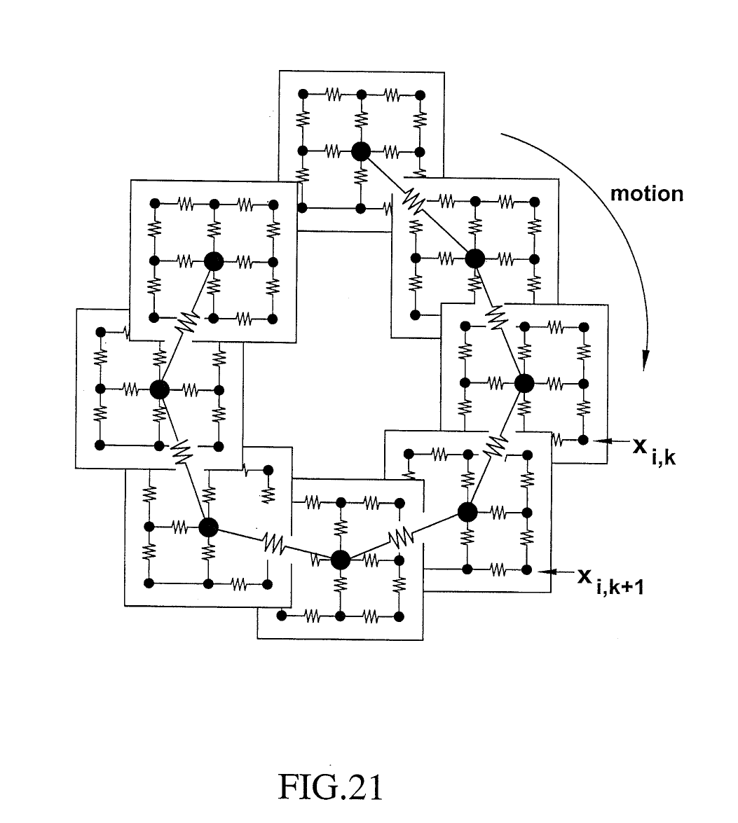

One embodiment of the invention involves correcting for scene deformation. This can be accomplished, for example, by integrating deformable surface models into the image mosaicing algorithms. Each image is partitioned into several patches. A node is assigned to the center of each patch. The number of patches depends on the amount of anticipated deformation, since too small of a patch size will not be able to accurately recover larger deformations. In addition to the global constraints, or springs, between neighboring images, local constraints are placed between the neighboring nodes within each image. As before, these constraints can be bent, but bending them incurs a penalty. FIG. 21 illustrates this idea. To measure the amount of deformation, the partitioned patches are registered in each image with the corresponding patches in the previous image using gradient descent.

Each image xk is assigned a collection of local nodes denoted by

x_{i,k}=(x_{i,k},y_{i,k})^{T}. (8)

Two new sets of constraints are introduced to the local nodes within each image. The first set of constraints is based on a node's relative position to its neighbors within an individual image,

$$δ {x}_{i -> j , k} = \underbrace{{x}_{j , k} - {x}_{i , k}}_{= : δ {\hat{x}}_{i -> j , k}} . \qquad ( 9 )$$

Here, δx_{i→j,k} is a constant value that represents the nominal spacing between the nodes. The second set of constraints is based on the node's relative position to the corresponding node in a neighboring image,

$$δ {x}_{i , k -> l} = \underbrace{{x}_{i , l} - {x}_{i , k}}_{= : δ {\hat{x}}_{i , k -> l}} . \qquad ( 10 )$$

Here, δx_{i,k→l} contains the measured local deformation. To accommodate non-rigid deformations in the scene, a violation of these local link constraints is allowed, and the familiar Gaussian potentials are applied:

$$\begin{matrix}{g}_{i -> j , k} = {\vert 2 π {Θ}_{1} \vert}^{- \frac{1}{2}} exp \{ - \frac{1}{2} {( \begin{matrix}δ {x}_{i -> j , k} - \\ δ {\hat{x}}_{i -> j , k}\end{matrix} )}^{T} {Θ}_{1}^{- 1} ( \begin{matrix}δ {x}_{i -> j , k} - \\ δ {\hat{x}}_{i -> j , k}\end{matrix} ) \} & ( 11 ) \\ {g}_{i , k -> l} = {\vert 2 π {Θ}_{2} \vert}^{- \frac{1}{2}} exp \{ - \frac{1}{2} {( \begin{matrix}δ {x}_{i , k -> l} - \\ δ {\hat{x}}_{i , k -> l}\end{matrix} )}^{T} {Θ}_{2}^{- 1} ( \begin{matrix}δ {x}_{i , k -> l} - \\ δ {\hat{x}}_{i , k -> l}\end{matrix} ) \} & ( 12 )\end{matrix}$$

Here, Θ1 and Θ2 are diagonal matrices that reflect the rigidity of the surface (and amount of allowable deformation). The negative logarithm of these potentials, summed over all links, is written as (constant omitted)

$$G = {\sum }_{i -> j , k} {( δ {x}_{i -> j , k} - δ {\hat{x}}_{i -> j , k} )}^{T} {Θ}_{1}^{- 1} ( δ {x}_{i -> j , k} - δ {\hat{x}}_{i -> j , k} ) + {\sum }_{i , k -> l} {( δ {x}_{i , k -> l} - δ {\hat{x}}_{i , k -> l} )}^{T} {Θ}_{2}^{- 1} ( δ {x}_{i , k -> l} - δ {\hat{x}}_{i , k -> l} ) \qquad ( 13 )$$

G can be written as a set of linear equations using state vectors and the Jacobian of the motion equations. The optimization algorithm is used to minimize the combined target function

$${min}_{δ x , Δ x} ( G + H ) \qquad ( 14 )$$

to simultaneously recover the global image locations as well as the local scene deformation. The solution can be found using the aforementioned least-squares approach.

In an alternative embodiment, each image location and its local nodes, as denoted in equation eq(8), includes information about rotation as well as translation. In this alternative embodiment, equations eq(9), eq(10), eq(11), eq(12), and eq(13) would be also be modified to incorporate rotation. In this alternative embodiment, the target function eq(14) would be minimized using a non-linear least squares routine.

In one embodiment, after the scene deformation is corrected for, the images are un-warped according to the recovered deformation using Gaussian radial basis functions. In an alternative embodiment, the images could be un-warped using any other type of radial basis functions such as thin-plate splines. In an alternative embodiment, the images could be un-warped using any other suitable technique such as, for example, bilinear interpolation.

Scene deformations and cumulative errors are corrected simultaneously. In an alternative embodiment, scene deformations and cumulative errors are corrected for independently at different instances. In one instance, the pair-wise image mosaicing occurs in real-time, and cumulative errors and/or scene deformation are corrected after a loop is closed or the image path traces back upon a previously imaged area. In this instance, the pair-wise mosaicing can occur on a high priority thread, and cumulative errors and/or scene deformations are corrected on a lower priority thread. The mosaic is updated to avoid interruption of the real-time mosaicing. In an alternative embodiment, the real-time mosaicing may pause while cumulative errors and/or scene deformations are corrected. In another alternative embodiment, cumulative errors and/or scene deformations are corrected off-line after the entire image set has been obtained. In one embodiment, cumulative errors and/or scene deformations are corrected automatically using algorithms that detect when a loop has been closed or an image has traced back upon a previously imaged area. In an alternative embodiment, cumulative errors and/or scene deformations are corrected at specific instances corresponding to user input.

The multiple images of portions from a single scene are taken using an imaging device. The imaging device's field of view is moved to capture different portions of the single scene. The images are processed in real-time to create a composite image mosaic for display. Corrections are made for cumulative image registration errors and scene deformation and used to generate a mosaic image of the single scene. As an example of such an embodiment, the imaging device is a micro-endoscope capable of imaging at a single tissue depth, and the scene is an area of tissue corresponding to a single depth.

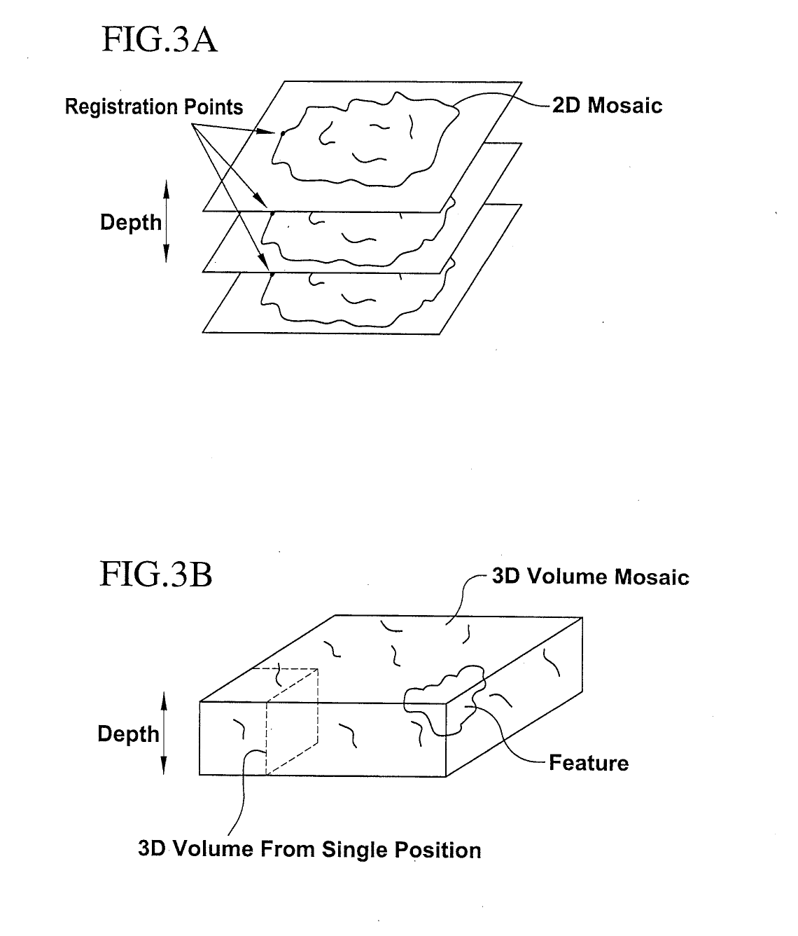

FIG. 3A shows an embodiment where the processes discussed herein can be applied to more than one scene. For instance, the imaging device can be a confocal micro-endoscope capable of imaging at different depths in tissue. Mosaics are created for the different depths in the tissue, and these mosaics are then registered to each other for 3D display. Referring to FIG. 3B: as another example of this alternative embodiment, a full 3D volume is obtained by the imaging device, and this 3D data is processed using a variation of the methods described.

Image registration for 3D mosaicing can be achieved using a variety of techniques. In a specific embodiment, overlapping images in a single cross-sectional plane are mosaiced using the image registration techniques discussed previously. When the imaging depth changes by a known amount, a new mosaic is started at the same 2D location but at the new depth, and the display is updated accordingly. In another specific embodiment, image stacks are acquired by a confocal microscope, where each stack is obtained by keeping the microscope relatively still and collecting images at multiple depths. Image registration is performed on images at the same depth (for example, the first image in every stack), and the result of this registration is used to mosaic the entire stack. In another specific embodiment, the image stacks are registered using 3D image processing techniques such as, for example, 3D optical flow, 3D feature detection and matching, and/or 3D cross-correlation in the spatial or frequency domains. The resulting 3D image mosaic is displayed with specific information regarding the geometric dimensions and location relative to the imaging device. In another specific embodiment, image stacks are acquired at two or more locations in a 3D volume to define registration points, and the resulting 3D mosaic is created using these registration points for reference. If there are cumulative errors and or scene deformation in the 3D mosaic, then they can be corrected for using methods, such as those involving increasing dimensions or applying the lower dimensional case multiple times on different areas.

Specific embodiments of the present invention include the use of a positional sensor in the mosiacing process. The following description of such embodiments of the invention is not intended to limit the invention to these embodiments, but rather to enable any person skilled in the art to make and use this invention.

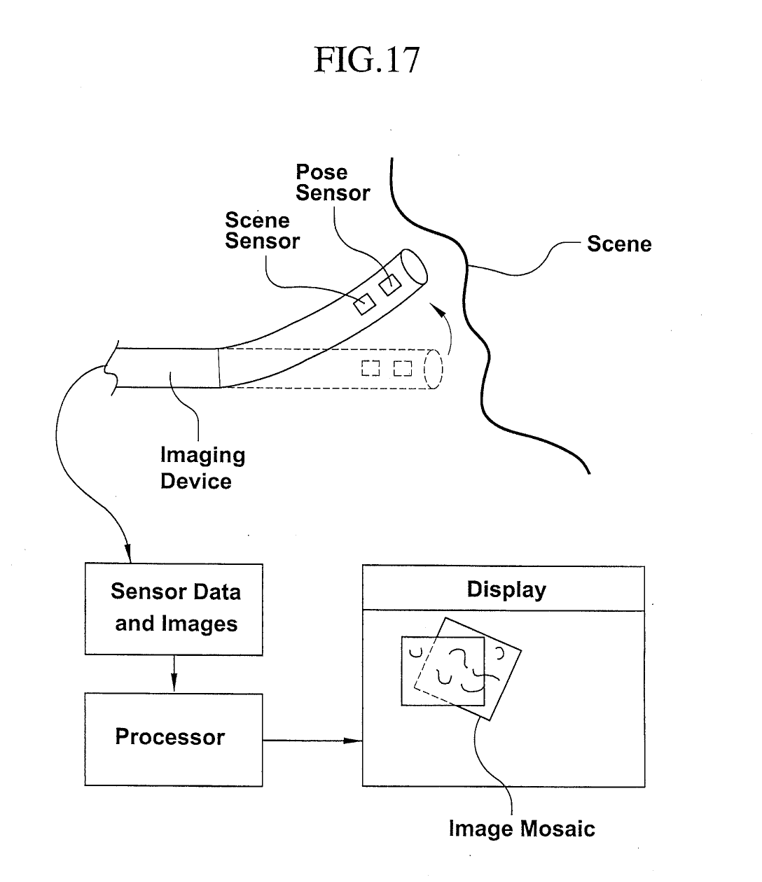

As shown in FIG. 17, the system of one embodiment of the invention includes: (1) an imaging device for capturing images of a near-field scene; (2) one or more state sensors for measuring the state of the imaging device at different poses relative to a reference pose; (3) one or more sensors for measuring external scene geometry and dynamics; (4) an optional control unit for moving the imaging device to cover a field-of-view wider than the original view; and (5) a processor for processing the images and sensor information to create a composite image mosaic for display.

One embodiment of the invention is specifically designed for real-time image mosaicing of tissue structures during in vivo medical procedures. Other embodiments of the invention, however, may be used for image mosaicing of any other near-field scene. Such nonmedical uses may include structural health monitoring of aircraft, spacecraft, or bridges, underwater exploration, terrestrial exploration, and other situations where it is desirable to have a macro-scale field-of-view while maintaining micro-scale detail.

The imaging device of one embodiment functions to capture images of a near-field scene. The system may include one or more imaging devices. The imaging device can be a micro-endoscope, imaging probe, confocal microscope, or any other imaging device that can be used for medical procedures such as, for example, cellular inspection of tissue structures, colonoscopy, or imaging inside a blood vessel. Further, the imaging device may include a digital camera, video camera, film camera, CMOS or CCD image sensor, or any other imaging apparatus that records the image of an object. As an example, the imaging device may be a miniature diagnostic and treatment capsule or “pill” with a built-in CMOS imaging sensor that travels through the body for micro-imaging of the digestive track.

The state sensor of the one embodiment functions to measure linear or angular acceleration, velocity, and/or position and determine the state of the imaging device. The sensor for measuring the state of the imaging device can be mounted on or near the imaging device: In one example, the sensor is a micro-electromechanical systems (MEMS) sensor, such as an accelerometer or gyroscope, electromagnetic coil, fiber-optic cable, optical encoder mounted to a rigid or flexible mechanism, measurement of actuation cables, or any other sensing technique that can measure linear or angular acceleration, velocity, and/or position.

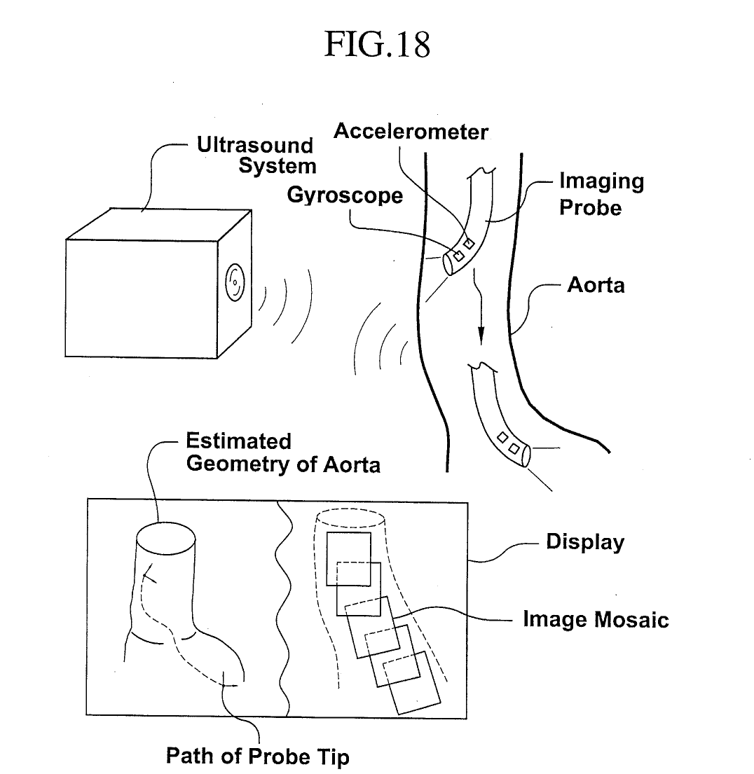

In a second variation, as shown in FIG. 18, the sensor may be remotely located (i.e., not directly mounted on the imaging device), and may be an optical tracking system, secondary imaging device, ultrasound, magnetic resonance imaging (MRI), X-ray, or computed tomography (CT). As an example, the imaging device may be an imaging probe that scans the inner wall of the aorta. An esophageal ultrasound catheter along with image processing is used to locate the position of the probe as well as the surface geometry of the aorta. The probe itself has a gyroscope to measure orientation and an accelerometer for higher frequency feedback.

In one embodiment, several sensors are used to measure all six degrees-of-freedom (position and orientation) of the imaging device, but alternatively any number of sensors could be used to measure a desired number of degrees-of freedom.

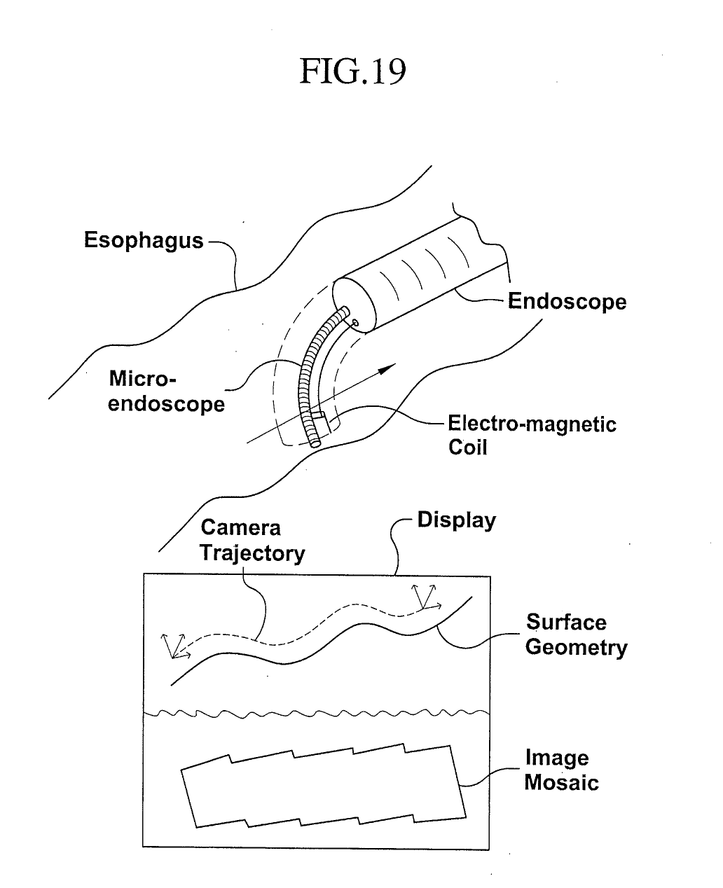

The external scene sensor of one embodiment functions to measure external scene geometry and dynamics. In a first variation, as shown in FIG. 19, the external scene sensor consists of the same sensor used to measure the state of the imaging device, which may or may not include additional techniques such as geometric contact maps or trajectory surface estimation. As an example, the imaging device is a micro-endoscope for observing and treating lesions in the esophagus, and the tip of the micro-endoscope is equipped with an electro-magnetic coil for position sensing. The micro-endoscope is dragged along the surface of the tissue. The position information can therefore be used to estimate the camera trajectory as well as the geometry of the surface.

In a second variation, the sensor for measuring external scene geometry and dynamics may be an additional sensor such as a range-finder, proximity sensor, fiber optic sensor, ultrasound, secondary imaging device, pre-operative data, or reference motion sensors on the patient.

In a third variation, the sensor for measuring external scene geometry and dynamics could be three-dimensional (3D) image processing techniques such as structure from motion, rotating aperture, micro-lens array, scene parallax, structured light, stereo vision, focus plane estimation, or monocular perspective estimation.

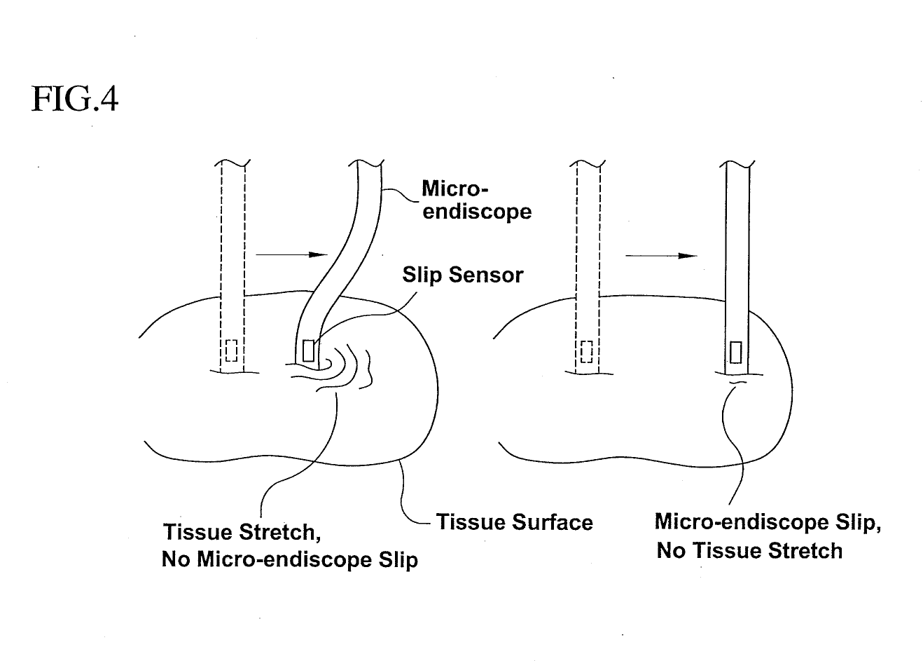

In a fourth variation, as shown in FIG. 4, external scene dynamics are introduced by the image mosaicing process and are measured by a slip sensor, roller-ball sensor, or other type of tactile sensor. As an example, the imaging device is a micro-endoscope that is being dragged along a surface tissue. This dragging will cause local surface motion on the volume (i.e. tissue stretch or shift), rather than bulk volume motion (i.e. patient motion such as lungs expanding while breathing). This is analogous to a water balloon where one can put their finger on it and move their finger around while fixed to the surface. Using the assumption that the surface can move around on the volume but maintains its surface structure locally underneath the micro-endoscope, the surface is parameterized by the distance the micro-endoscope has moved along the surface. The distance that the micro-endoscope tip has traversed along the surface is measured using a tactile sensor.

In a fifth variation, the dynamic 3D scene information is obtained using an ultrasound esophageal probe operating at a high enough frequency.

In a sixth variation, the dynamic 3D scene information is obtained by articulating the imaging device back and forth at a significantly higher frequency than the frequency of body motion. As an example, the imaging device is an endoscope for imaging inside the lungs. The endoscope acquires images at a significantly higher speed than the endoscope motion, therefore providing multiple sets of approximately static images. Each set can be used to deduce the scene information at that point in time, and all of the sets can collectively be used to obtain the dynamic information.

In a seventh variation, the dynamic 3D scene information is obtained by gating of the image sequence according to a known frequency of motion. As an example, the imaging device is an endoscope for imaging inside the lungs, and the frequency of motion is estimated by an external respiration sensor. The images acquired by the endoscope are gated to appear static, and the dynamic scene information is captured by phasing the image capture time.

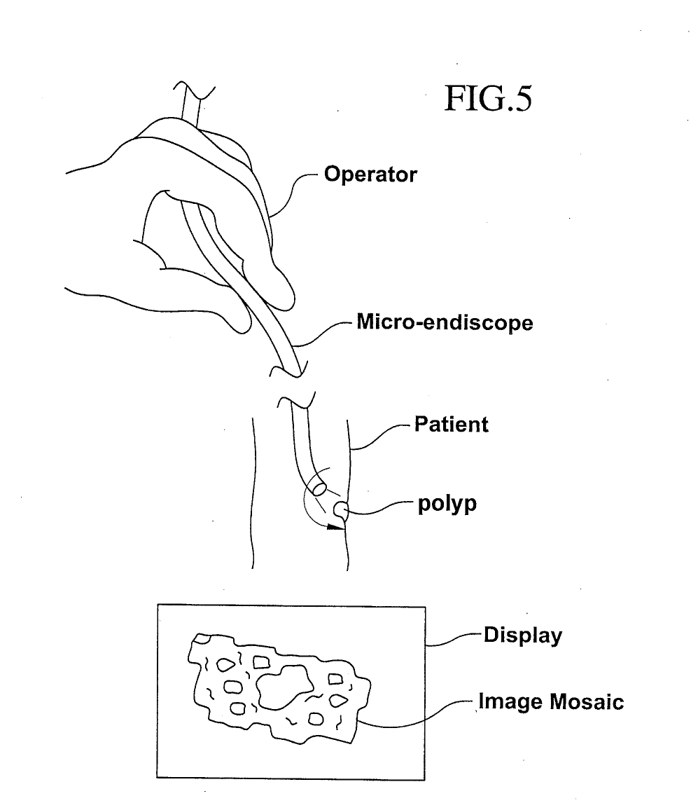

As shown in FIG. 5, the imaging device of one embodiment is passive and motion is controlled by the operator's hand. For example, the imaging device could be a micro-endoscope that obtains sub-millimeter images of the cells in a polyp. The operator holds the distal end of the micro-endoscope and scans the entire centimeter-sized polyp to create one large composite image mosaic for cancer diagnosis. The imaging device of alternative embodiments, however, may include a control unit that functions to move or direct the imaging device to cover a field-of-view wider than the original view.

In a first variation, as shown in FIG. 6, the imaging device is actuated using semi-automatic control and navigation by mounting it on a robotic arm. The operator either moves the robotic arm manually or tele-operates the robotic arm using a joystick, haptic device, or any other suitable device or method. Knowledge of the 3D scene geometry may be used to create a virtual surface that guides the operator's manual or tele-operated movement of the robotic arm so as to not contact the scene but maintain a consistent distance for focus. The operator may then create a large image mosaic “map” with confidence that the camera follows the surface appropriately.

In a second variation, the imaging device is mounted to a robotic arm that employs fully-automatic control and navigation. Once the robotic arm has been steered to an initial location under fully-automatic control or tele-operation, the robot can take full control and scan a large area for creating an image mosaic. This fully-automatic approach ensures repeatability and allows monotonous tasks to be carried out quickly.

In a third variation, if gaps in the image mosaic are present, the operator or image processing detects them and the imaging device is moved under operator, semi-automatic, or fully-automatic control to fill in the gaps. In a fourth variation, if there are large errors in the mosaic, the operator or image processing detects them and the imaging device is moved under operator, semi-automatic, or fully-automatic control to clean the mosaic up by taking and processing additional images of the areas with errors.

In a fifth variation, as shown in FIG. 7, the image mosaic is used as a navigation map for subsequent control of the imaging device. That is, a navigation map is created during a first fly through over the area. When the imaging device passes back over this area, it determines its position by comparing the current image to the image mosaic map. The display shows tracker dots overlaid on the navigation map to show the locations of the imaging device and other instruments. Alternatively, once a 3D image map is created, the operator can select a specific area of the map to return to, and the camera can automatically relocate based on previously stored and current information from the sensors and image mosaic.

In a sixth variation, as shown in FIG. 8, the imaging device is a capsule with a CMOS sensor for imaging in the stomach, and the sensor for measuring scene geometry is a range finder. Motion of the capsule is generated by computer control or tele-operated control. When the capsule approaches a curve, the range-finder determines that there is an obstruction in the field-of-view and that the capsule is actually imaging two surfaces at different depths. Using the range-finder data to start building the surface map, the image data can be parsed into two separate images and projected on two corresponding sections of the surface map. At this point there is only a single image, and the parsed images will therefore have no overlap with any prior images. The capsule then moves inside the stomach to a second location and takes another image of the first surface. In order to mosaic this image to the surface map, the position and orientation of the capsule as well as the data from the range-finder can be used.

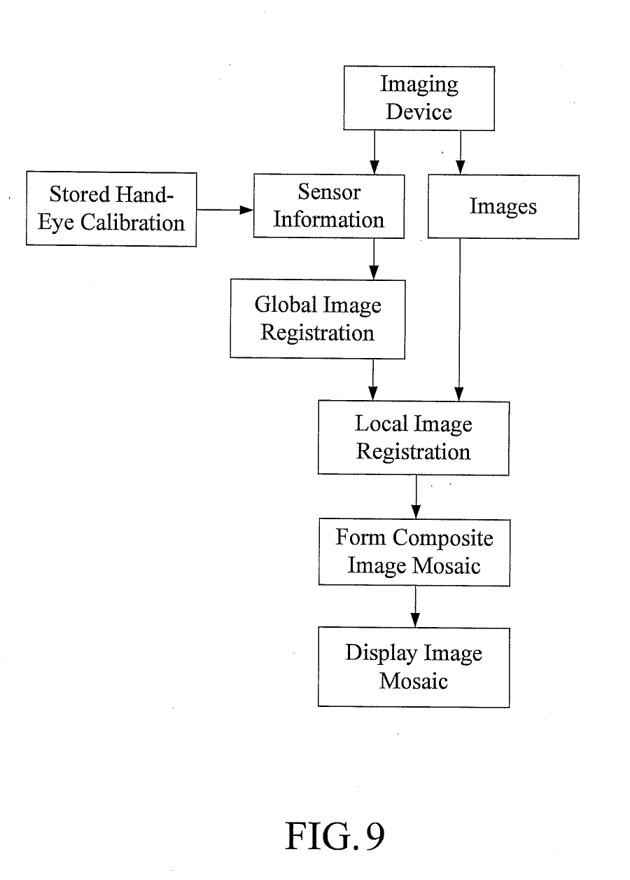

As shown in FIG. 9, the processor of one embodiment functions to process the images and sensor information to create and display a composite image mosaic. The processor can perform the following steps: (a) using sensor information to determine the state of the imaging device as well as external scene geometry and dynamics; (b) performing a sensor-to-camera, or hand-eye, calibration to account for sensor offset; (c) performing an initial, or global, image registration based on the sensor information; (d) performing a secondary, or local, image registration using computer vision algorithms to optimize the global registration; (e) using the image registration to stitch two or more images together to form a composite image mosaic; and (f) displaying the composite image mosaic.

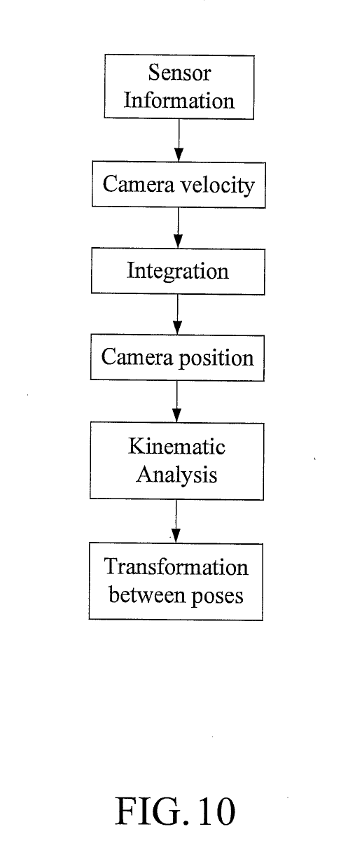

As shown in FIG. 10, prior to image processing, sensors are used to measure both the state of the imaging device (that is, its position and orientation) as well as the 3D geometry and dynamics of the scene. If a sensor measures velocity, for example, the velocity data can be integrated over time to produce position data. The position and orientation of the imaging device at a certain pose relative to a reference pose are then used to determine the transformation between poses. If the imaging device is mounted to a robot or other mechanism, a kinematic analysis of that mechanism can be used to find the transformation.

In one embodiment, an entire image (pixel array) is captured at a single point in time, and sensor information is therefore used to determine the state of the imaging device, as well as the 3D geometry and dynamic state of the scene, at the corresponding image capture time. In other situations, the imaging device may be moving faster than the image acquisition rate. In alternative embodiments, used for these situations, certain portions, or pixels, of an image may be captured at different points in time. In such alternative embodiments, sensor information is used to determine the several states of the imaging device, as well as several 3D geometries and dynamic states of the scene, as the corresponding portions of the image are acquired.

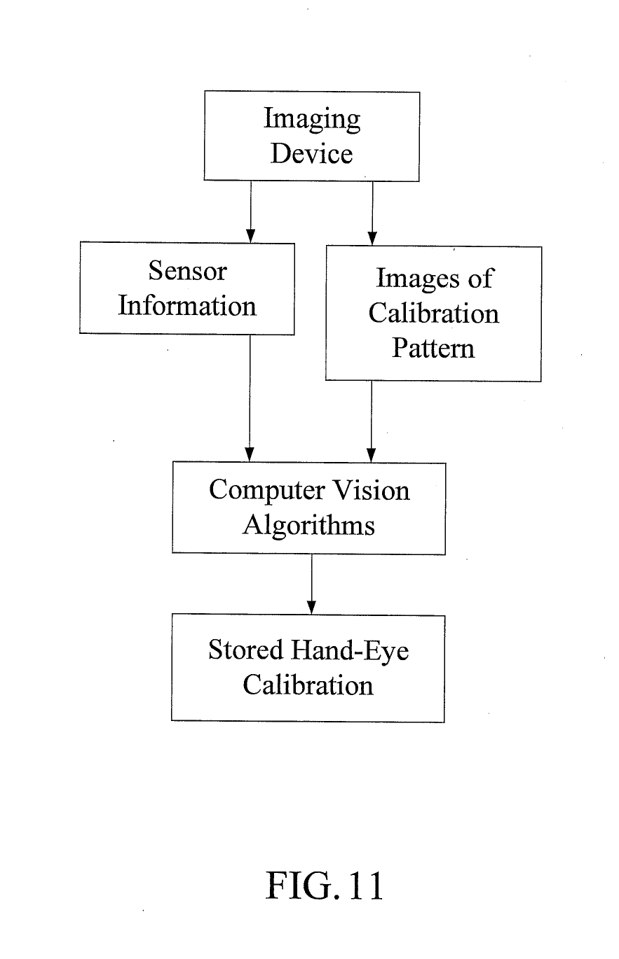

In many instances, the sensors measuring the state of the imaging device will have an offset. That is, the transformations between poses of the imaging device will correspond to a point near, but not directly on, the optical center of the imaging device. This offset is accounted for using a sensor-to-camera, or “hand-eye” calibration, which represents the position and orientation of the optical center relative to the sensed point. In the one embodiment, as shown in FIG. 11, the hand-eye calibration is obtained prior to the image mosaicing by capturing images of a calibration pattern, recording sensor data that corresponds to the pose of the imaging device at each image, using computer vision algorithms (such as a standard camera calibration routine) to estimate the pose of the optical center at each image, and solving for the hand-eye transformation.

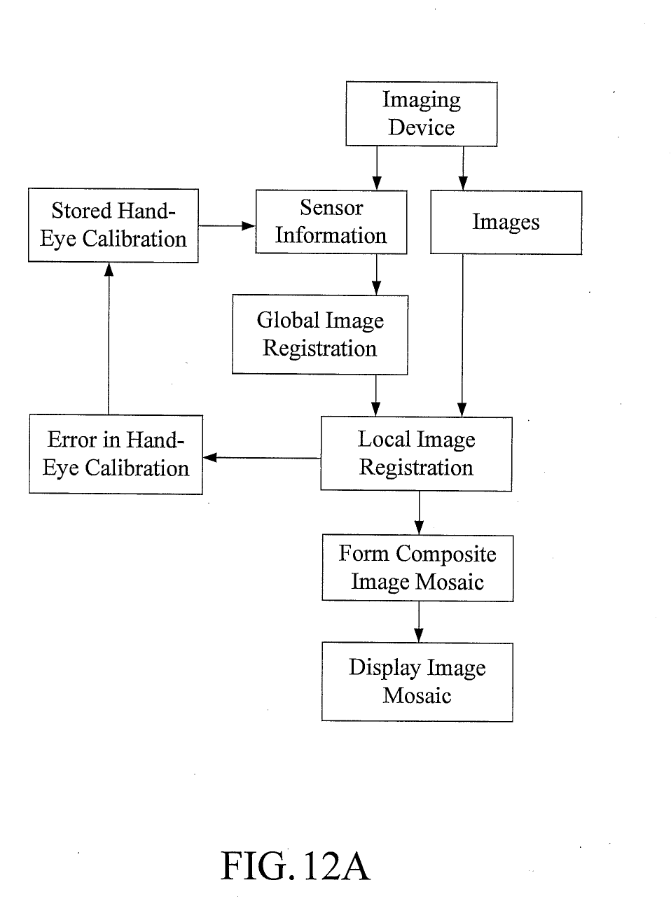

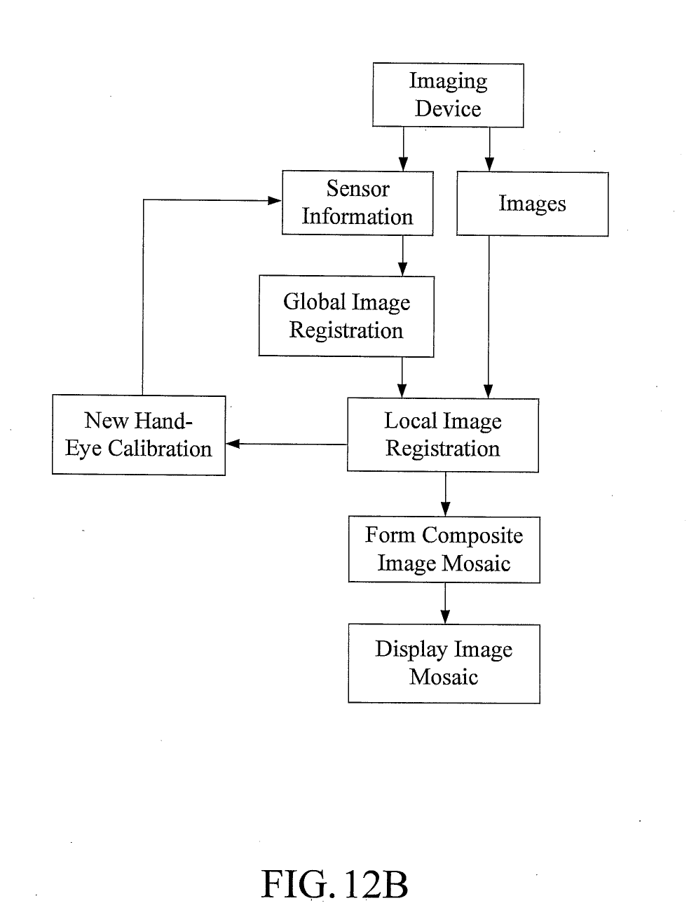

If static error is reoccurring during the image mosaicing, it is likely that there is error in the hand-eye calibration, and thus the mosaic information could improve the hand-eye calibration, as shown in FIG. 12a. The previously-computed hand-eye calibration may be omitted, as shown in FIG. 12b, and a new hand-eye calibration is determined during the image mosaicing by comparing the sensor data to results of the image registration algorithms. The resulting hand-eye transformation is used to augment the transformation between poses.

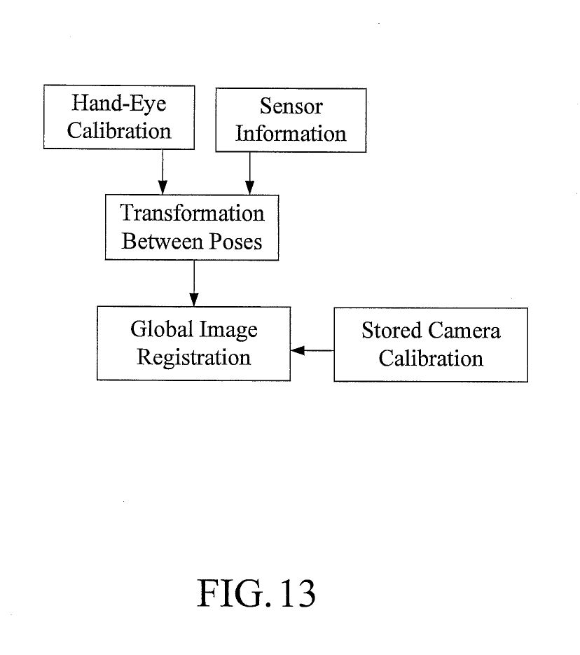

As shown in FIG. 13, the augmented transformation is combined with a standard camera calibration routine (which estimates the focal length, principle point, skew coefficient, and distortions of the imaging device) to yield the initial, or global, image registration. In one embodiment, the scene can be approximated as planar, and the global image registration is calculated as a planar nomography. In an alternative embodiment, however, the scene is 3D, and sensors are used to estimate the 3D shape of the scene for calculating a more accurate global image registration. This sensor-based global image registration can be useful in that it is robust to image homogeneity, may reduce the computational load, remove restrictions on image overlap and camera motion and reduce cumulative errors. This global registration may not, however, have pixel-level accuracy. In the situations that require such accuracy, the processor may also include steps for a secondary image registration.

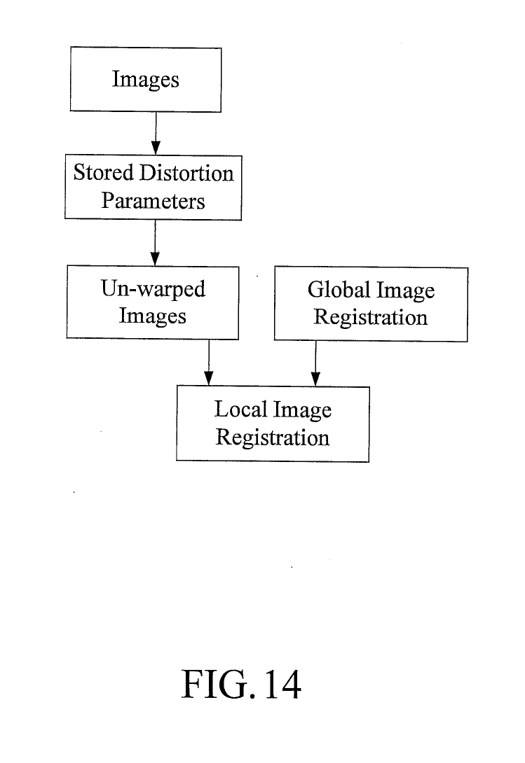

As shown in FIG. 14, the secondary (or local) image registration is used to optimize the results of the global image registration. Prior to performing the local image registration, the images are un-warped using computer-vision algorithms to remove distortions introduced by the imaging device. In the one embodiment, the local image registration uses computer-vision algorithms such as the Levenberg-Marquardt iterative nonlinear routine to minimize the discrepancy in overlapping pixel intensities. In an alternative embodiment, the local image registration could use optical flow, feature detection, correlation in the spatial or frequency domains, or any other image registration algorithm. These algorithms may be repeatedly performed with down-sampling or pyramid down-sampling to reduce the required processing time.

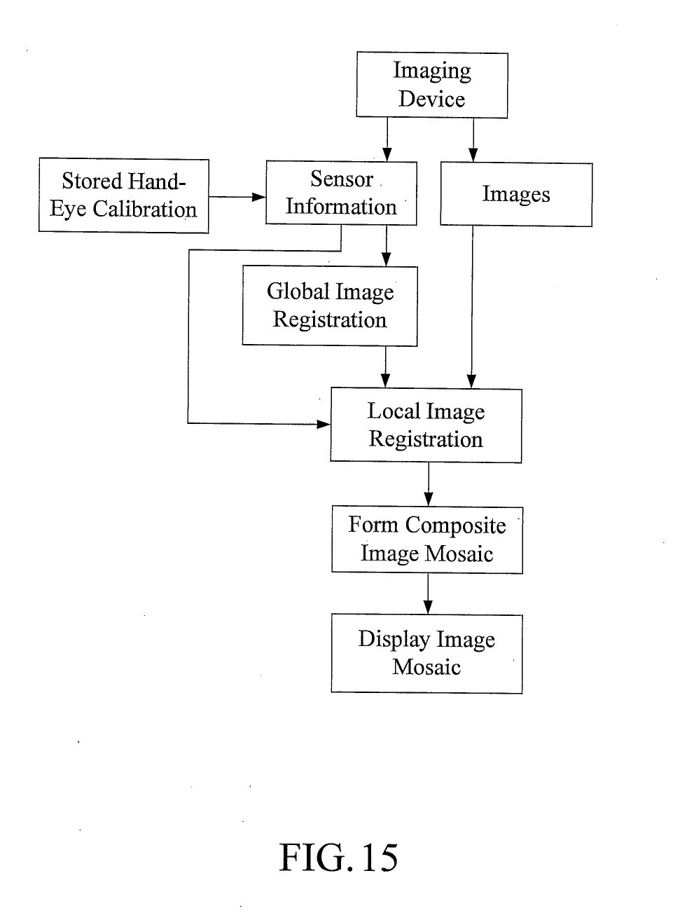

In an alternative embodiment, as shown in FIG. 15, the sensor data is used to speed up the local image alignment in addition to providing the global image alignment. One method is to use the sensor data to determine the amount of image overlap, and crop the images such that redundant scene information is removed. The resulting smaller images will therefore require less processing to align them to the mosaic. This cropping can also be used during adaptive manifold projection to project strips of images to the 3D manifold. The cropped information could either be thrown away or used later when more processing time is available.

In another alternative embodiment, the sensor data is used to define search areas on each new image and the image mosaic. That is, the secondary local alignment can be performed on select regions that are potentially smaller, thereby reducing processing time.

In another embodiment, the sensor data is used to pick the optimal images for processing. That is, it may be desirable to wait until a new image overlaps the mosaic by a very small amount. This is useful to prevent processing of redundant data when there is limited time available. Images that are not picked for processing can either be thrown away or saved for future processing when redundant information can be used to improve accuracy.

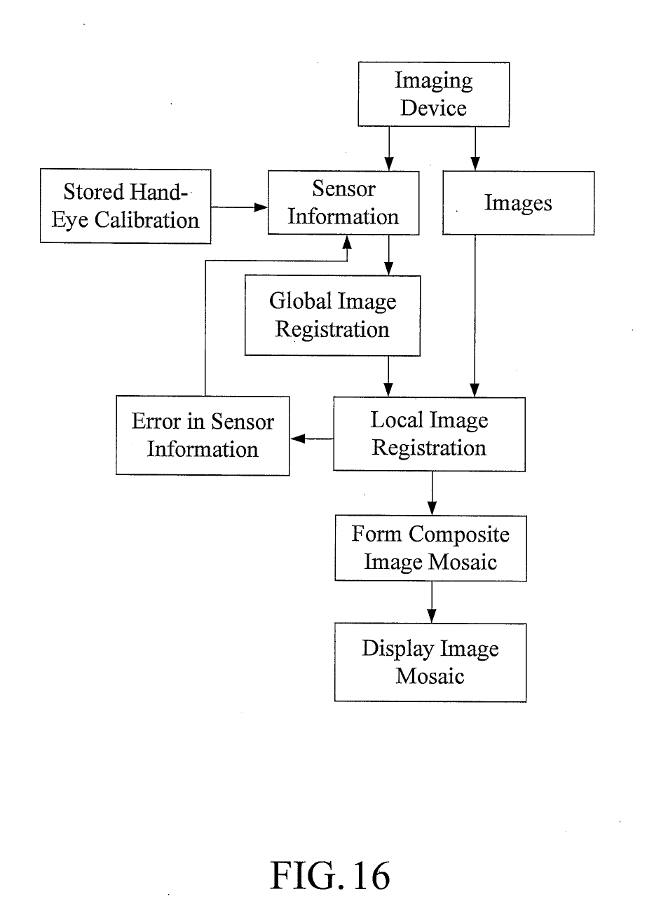

In one embodiment, as shown in FIG. 16, the global image registration can be accurate to a particular level such that only a minimal amount of additional image processing is required for the local image registration. In an alternative embodiment, however, the global image registration will have some amount of error, and the result of the mosaicing algorithms is therefore sent through a feedback loop to improve the accuracy of the sensor information used in subsequent global image registrations. In an alternative embodiment, this reduced error in sensor information is used in a feedback loop to improve control. This feedback information could be combined with additional algorithms such as a Kalman filter for optimal estimation.

The result of the secondary, or local, image registration is used to add a new image to the composite image mosaic through image warping, re-sampling, and blending. If each new image is aligned to the previous image, small alignment errors will propagate through the image chain, becoming most prominent when the path closes a loop or traces back upon itself. Therefore, in the one embodiment, each new image is aligned to the entire image mosaic, rather than the previous image. In an alternative embodiment, however, each new image is aligned to the previous image. In another alternative embodiment, if a new image has no overlap with any pre-existing parts of the image mosaic, then it can still be added to the image mosaic using the results of the global image registration.

In one embodiment, the image mosaic is displayed by projecting the image mosaic onto a 3D shape corresponding to the geometry of the scene. This 3D geometry and its motion over time are measured by the sensors previously mentioned. In an alternative embodiment, for low curvature surfaces, the scene can be approximated as planar and the corresponding image mosaic could be projected onto a planar manifold. In an alternative embodiment, if the scene can be approximated as cylindrical or spherical, the resulting image mosaic can be projected onto a cylindrical or spherical surface, respectively. In an alternative embodiment, if the scene has high curvature surfaces, it can be approximated as piece-wise planar, and the corresponding image mosaic could be projected to a 3D surface (using adaptive manifold projection or some other technique) that corresponds to the shape of the scene. In an alternative embodiment, during fly-through procedures using, for example, a micro-endoscope, the image mosaic could be projected to the interior walls of that surface to provide a fly-through display of the scene. In an alternative embodiment, if the scene has high curvature surfaces, select portions of the images may be projected onto a 3D model of the scene to create a 3D image mosaic. In an alternative embodiment, if it is not desirable to view a 3D image mosaic, the 3D image mosaic can be warped for display on a planar manifold. In an alternative embodiment, if there are unwanted obstructions in the field-of-view, they can be removed from the image mosaic by taking images at varying angles around the obstruction.

In one embodiment the resulting image mosaic is viewed on a computer screen, but alternatively could be viewed on a stereo monitor or 3D monitor. In the one embodiment, the image mosaic is constructed in real-time during a medical procedure, with new images being added to the image mosaic as the imaging device is moved. In an alternative embodiment, the image mosaic is used as a preoperative tool by creating a 3D image map of the location for analysis before the procedure. In an alternative embodiment, the image mosaic is either created before the operation or during the operation, and tracker dots are overlaid to show the locations of the imaging device and other instruments.

In a specific embodiment it can be assumed that the camera is taking pictures of a planar scene in 3D space, which can be a reasonable assumption for certain tissue structures that may be observed in vivo. In this specific case, the camera is a perspective imaging device, which receives a projection of the superficial surface reflections. The camera is allowed any arbitrary movement with respect to the scene as long as it stays in focus and there are no major artifacts that would cause motion parallax.

Using homogeneous coordinates, a world point x=(x, y, z, 1) gets mapped to an image point u=(u, v, 1) through perspective projection and rigid transformation,

$$u = [ \begin{matrix}K & 0\end{matrix} ] [ \begin{matrix}R & T \\ {0}^{T} & 1\end{matrix} ] x , \qquad ( 15 )$$

where R and T are the 3×3 rotation matrix and 3×1 translation vector of the camera frame with respect to the world coordinate system. The 3×3 projection matrix K is often called the intrinsic calibration matrix, with horizontal focal length fx, vertical focal length fy, skew parameter s, and image principle point (cx, cy).

u1 and u2 represent different projections of a point x on plane it. The plane can be represented by a general plane equation n (x, y, z)+d=0, where n is a unit normal extending from the image plane towards the first view and d is the distance between them. By orienting the world coordinate system with the first view, the relationship between the two views can be written as u2=Hu1, where H is a 3×3 homography matrix defined up to a scale factor.

$$H = K ( {R}_{12} + {T}_{12} \frac{{n}^{T}}{d} ) {K}^{- 1} . \qquad ( 16 )$$

In order to determine the homography between image pairs, an accurate measurement of the intrinsic camera parameters is useful. In one implementation, parameters of fx=934, fy=928, s=0, and (cx,cy)=(289, 291) were determined with roughly 1-3% error. This relatively large error is a result of calibrating at sub-millimeter scales. The camera calibration also provided radial and tangential lens distortion coefficients that were used to un-warp each image before processing. In addition, the images were cropped from 640×480 pixels to 480×360 pixels to remove blurred edges caused by the large focal length at near-field.

In near-field imaging, camera translations T are often on the same scale as the imaging distance d. If the assumption that T>>>d does not hold, it becomes increasingly important to measure camera translation in addition to orientation. Therefore the Phantom forward kinematics can be used to measure the rotation and translation of the point where the 3 gimbal axes intersect. Stylus roll can be ignored since it does not affect the camera motion. With these measurements, the transformation required in (16) can be calculated as

$$[ \begin{matrix}{R}_{1 j} & {T}_{1 j} \\ {0}^{T} & 1\end{matrix} ] = {[ \begin{matrix}{R}_{1} & {T}_{1} \\ {0}^{T} & 1\end{matrix} ]}^{- 1} [ \begin{matrix}{R}_{j} & {T}_{j} \\ {0}^{T} & 1\end{matrix} ] , \qquad ( 17 )$$

where R1 and T1 are the rotation and translation of the first view and Rj and Tj are the rotation and translation of all subsequent views as seen by the robot's reference frame.

The transformations in (17) refer to the robot end-effector. The transformations in (16), however, refer to the camera optical center. Thus, the process involves rigid transformation between the end-effector and the camera's optical center, which is the same for all views. This hand-eye (or eye-in-hand) transformation is denoted as a 4×4 transformation matrix X composed of a rotation Rhe and translation The.

To determine X two poses, C₁=A₁X and C₂=A₂X, are defined where C refers to the camera and A refers to the robot. Hand-eye calibration is most easily solved during camera calibration, where A is measured using the robot kinematics and C is determined using the calibration routine. Denoting C₁₂=C₁⁻¹C₂ and A₁2=A₁⁻¹A₂, obtains the hand-eye equation A₁₂X=XC₁₂. The resulting hand-eye transformation can be used to augment (17) which is in turn used in (16) to find H.

After estimating the homography between two images using position sensing, the resulting matrix H, however, may have errors and likely will not have pixel-level accuracy. To compensate, mosaicing algorithms can be integrated to accurately align the images. One such algorithm is a variation of the Levenberg-Marquardt (LM) iterative nonlinear routine to minimize the discrepancy in pixel intensities. The LM algorithm requires an initial estimate of the homography in order to find a locally optimal solution. Data obtained from the positioning sensor can be used to provide a relatively accurate initial estimate.

The various embodiments described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such modifications and changes do not depart from the true spirit and scope of the present invention.

What is claimed is:

1. A method for generation of a continuous image representation of an area from multiple images consecutively received from an image sensor, at least some of the multiple images overlapping one another, the method comprising:
indicating a location of a currently received image relative to the image sensor;
indicating a position of a currently received image relative to a set of previously received images with reference to the indicated location;
comparing the currently received image to the set of previously received images as a function of the indicated position;
responsive to the comparison, indicating adjustment information relative to the indicated position; and
merging the currently received image with the set of previously received images to generate data representing a new set of images.

2. The method of claim 1, wherein the indicated locations of a currently received image include a one-dimensional, two-dimensional or three-dimensional section of a three-dimensional volume.

3. The method of claim 1, wherein the step of merging includes warping one of the currently received image and the set of previously received images.

4. The method of claim 1, wherein the image sensor captures images using near-field imaging implemented using a confocal microscope.

5. The method of claim 1, further including the step of displaying the new set of images.

6. The method of claim 5, wherein the step of displaying is performed in real-time relative to receipt of the currently received image.

7. The method of claim 5, wherein the steps of indicating, merging and displaying are repeated for each newly received image and respective new set of images and the multiple images are obtained in vivo.

8. The method of claim 1, wherein the step of indicating a position includes the use of a sensor to detect motion of the image sensor.

9. The method of claim 1, wherein the step of indicating a position includes using optical flow to detect image sensor motion from consecutively received images and the step of indicating adjustment information includes a global adjustment to a position of images within the set of previously received images.

10. The method of claim 1, wherein the step of merging includes implementing an algorithm to combine pixels of the currently received image with the set of previously received images using blending and/or discarding of overlapping pixels.

11. The method of claim 1, wherein the step of indicating a position includes the use of one of an accelerometer, a gyroscope, an encoder, an optical encoder, an electro-magnetic coil, an impedance field sensor, a fiber-optic cable, robotic arm position detector, a camera, an ultrasound, an MRI, an x-ray, a CT, and an optical triangulation.

12. The method of claim 1, wherein the steps of indicating a position or adjustment information includes the use of one of optical flow, feature detection and matching, and correlation in the spatial or frequency domain.

13. The method of claim 1, wherein the indicating a position or adjustment information includes information about one of position and orientation.

14. The method of claim 1, wherein the indicated position or adjustment information are subject to cumulative errors or scene deformation, and an algorithm is used to correct for the cumulative errors or scene deformation.

15. The method of claim 1, further including the step of correcting for the cumulative errors or scene deformation of the currently received image.

16. The method of claim 1, wherein the image sensor is moved using mechanical actuation.

17. The method of claim 1, wherein one or more steps are repeated to improve the quality of the continuous image representation.

18. The method of claim 1, wherein an image is comprised of multiple pixels.

19. A system for generation of a continuous image representation of an area from multiple images consecutively received from an image sensor, at least some of the images overlapping one another, the system comprising:
means for indicating a location of a currently received image relative to the image sensor;
means for indicating a position of a currently received image to a set of previously received images with reference to the indicated location;
means for comparing the currently received image relative to the set of previously received images as a function of the indicated position;
means for responsive to the comparison, indicating adjustment information relative to the indicated position; and
means for merging the currently received image with the set of previously received images to generate data representing a new set of images.

20. A system for generation of a continuous image representation of an area from multiple images consecutively received from an image sensor, at least some of the images overlapping one another, the system comprising:
a processing circuit for indicating a location of a currently received image relative to the image sensor;
a processing circuit for indicating a position of a currently received image to a set of previously received images with reference to the indicated location;
a processing circuit for comparing the currently received image relative to the set of previously received images as a function of the indicated position;
a processing circuit for responsive to the comparison, indicating adjustment information relative to the indicated position; and
a processing circuit for merging the currently received image with the set of previously received images to generate data representing a new set of images.

21. The system of claim 20, further including the image sensor operating as a non-perspective imaging device wherein the circuit for indicating a position includes a positional sensor that detects movement of the image sensor.

22. The system of claim 20, further wherein the circuit for indicating a position includes a processor configured to detects movement of the image sensor using one of optical flow, feature detection and matching, and correlation in the spatial or frequency domain.

23. The system of claim 20, wherein the imaging device is a near-field imaging device.
